(19) United States
(12) Patent Application Publication
(10) Pub. No.: US 2003/0107660 A1
(43) Pub. Date: Jun. 12, 2003

(54) Electronic imaging camera

(75) Inventor: Yoji Watanabe, Fuchu-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 10/309,960

(22) Filed: Dec. 4, 2002

(30) Foreign Application Priority Data
Dec. 10, 2001 (JP) 2001-375849

(51) Int. Cl. H04N 5/76

(52) U.S. Cl. 348/231.5

(57) ABSTRACT

An electronic imaging camera has an image pickup element which converts an object image into an electric signal via an image pickup optical system. A signal processing section processes output from the image pickup element to generate image data. A memory section stores a plurality of image data. A date information output section outputs date information. The memory control section controls a storage operation to associate the image data with the date information and store them in the memory section and a read operation to read the image data stored in the memory section. The memory control section performs a first read operation to read the image data from the memory section in the order of image pickup and an second read operation to skip the image data of a same date and read the image data of a different date.

### CROSS-REFERENCE TO RELATED APPLICATIONS

This application is based upon and claims the benefit of priority from the prior Japanese Patent Application No. 2001-375849, filed Dec. 10, 2001, the entire contents of which are incorporated herein by reference.

### BACKGROUND OF THE INVENTION

1. Field of the Invention

The present invention relates to an electronic imaging camera and more particularly to an electronic imaging camera capable of easily reading images to be displayed on an LCD monitor and the like.

2. Description of the Related Art

At present, when a commercially available electronic imaging camera (digital camera) reproduces stored images on an LCD monitor, it is a general practice to display the most recent image (the last picked-up image) in accordance with reproduction mode setting. To display the other picked-up images, a user selects an intended image by pressing an image selection button for the necessary number of times. When the user intends to display an image by browsing back many frames, e.g., 20 frames back from the last one, the user needs to press the image selection button as many as 20 times. Such an operation is likely to bother the user. Some cameras are provided with a skip selection button to skip a specified number of frames (e.g., five frames) for selecting an intended image. This mechanism requires just four button operations to display the image which is located 20 frames back from the last one.

When the user remembers the number of the image to be displayed or the number of frames to be moved back for displaying the intended image, the conventional method enables easy selection of the intended image by combination of the skip button and the sequential selection button. Normally, however, the user hardly remembers the number of the image to be displayed. Consequently, there has been a case of confusing the user when he or she moves back too many images for selection.

### BRIEF SUMMARY OF THE INVENTION

It is therefore an object of the present invention to provide an electronic imaging camera comprising:

an image pickup element configured to convert an object image into an electric signal via an image pickup optical system;

a signal processing section configured to process output from the image pickup element and generate image data;

a memory section configured to store a plurality of image data;

a date information output section configured to output date information; and

a memory control section configured to control storage operations which associate the image data with the date information from the date information output section, and store them in the memory section and read operations which read the image data stored in the memory section,

wherein the memory control section performs a first read operation to read the image data from the memory section in the sequential order of image pickup and a second read operation to skip the image data of a same date and read the image data of a different date.

A second aspect of the invention concerns the electronic imaging camera according to the first aspect of the invention, further comprising an input section configured to supply the memory control section with a signal for activating the first read operation or the second read operation in response to a manual operation.

A third aspect of the invention concerns the electronic imaging camera according to the second aspect of the invention, wherein the input section outputs first and second signals, and the memory control section performs the first read operation in accordance with the first signal and performs the second read operation in accordance with the second signal.

A fourth aspect of the invention concerns the electronic imaging camera according to the first aspect of the invention, wherein the second read operation reads as a next read operation image data associated with date information differing from that for the most recently read image data.

A fifth aspect of the invention concerns the electronic imaging camera according to the first aspect of the invention, wherein the memory control section performs the first read operation to read image data in the forward or reverse order of image pickup based on the most recently read image data and performs a second read operation to read image data having a date previous or subsequent to a date of the most recently read image data.

A sixth aspect of the invention is an electronic imaging camera comprising:

an image pickup section configured to pick up an object image;

a date information output section configured to output date information;

a storage section configured to store image data picked up by the image pickup section, the image data being associated with date information output from the date information output section; and

a display section configured to selectively read and display the image data based on the date information as a retrieval key.

A seventh aspect of the invention concerns the electronic imaging camera according to claim 6, further comprising an input section configured to instruct to change image data displayed in the display section, wherein the display section reads and displays image data having a date differing from that for the currently displayed image data in accordance with an instruction signal from the input section.

An eighth aspect of the invention is an electronic imaging camera comprising:

a system controller configured to control an overall operation of the electronic imaging camera and includes an date information output circuit to output date information;

an image pickup element configured to convert an object image into an electric signal via an image pickup optical system;

an image pickup processing circuit configured to process output from the image pickup element and generates image data;

a memory card configured to store a plurality of image data;

an image processing controller configured to control storage operations for associating the image data with the date information and storing them in the memory, and read operations for reading the image data stored in the memory section, in accordance with an instruction signal from the system controller;

a display control section configured to convert the read image data into display data; and

a display section configured to display the display data,

wherein the image processing controller performs a first read operation to read the image data from the memory section in the forward or reverse order of image data storage and a second read operation to read the image data by skipping the image data of a same date and read the image data of a different date.

A ninth aspect of the invention concerns the electronic imaging camera according to the eighth aspect of the invention, wherein the control circuit is provided with a plurality of switches and outputs a read control signal to the image processing controller in accordance with a signal from the switch.

A tenth aspect of the invention concerns the electronic imaging camera according to the ninth aspect of the invention, wherein the control circuit supplies the image processing controller with the control signal to perform the first read operation in accordance with first and second switch signals out of the plurality of switches and supplies the control signal to perform the second read operation in accordance with third and fourth switch signals out of the plurality of switches.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 shows an external rear elevation of an electronic imaging camera according to the present invention;

FIG. 2 shows a circuit block of the electronic imaging camera according to an embodiment of the present invention;

FIGS. 3A and 3B schematically show a data recording area in memory according to the embodiment of the present invention;

FIG. 4 is a detailed circuit block diagram exemplifying a system configuration of the electronic imaging camera according to the embodiment of the present invention; and

FIG. 5 is a flowchart showing a process of controlling the electronic imaging camera according to the embodiment of the present invention.

### DETAILED DESCRIPTION OF THE INVENTION

Embodiments of the present invention will be described in further detail with reference to the accompanying drawings.

First, an outline of the present invention will be described.

As a general manner of using a camera, the whole photography seldom finishes in a day, but often requires several days. An intended image can be easily retrieved if it is determined that the image was stored in the same day as that for a currently displayed image. Based on this concept, the electronic imaging camera according to the present invention associates a photographed object with the date when the object is photographed, and stores them in a nonvolatile storage element such as flash memory. In image reproduction mode, the camera finds and displays images assigned with dates different from the date for the currently displayed image in accordance with a skip button operation. When the intended images are photographed at the same date as for the currently displayed image, the selection button can be used sequentially to display the images one by one.

FIG. 1 shows an external rear elevation of an electronic imaging camera according to the present invention. As shown in FIG. 1, a camera body 1 includes an image pickup element and a memory element inside. A release button 2 activates an operation of the image pickup element to image an object. An imaging lens-barrel 3 guides an object to the image pickup element. A finder eyepiece 4 works as an optical finder eyepiece to observe an object. An LCD monitor screen 5 displays a picked-up image. An image display button 6 displays the most recent image on the LCD monitor. An up-button 7 is used to retrieve and display an image which was photographed before a date of the currently displayed image. An down-button 8 is used to retrieve and display an image which was photographed after a date of the currently displayed image. An right-button 9 is used to display an image immediately preceding the currently displayed image. An left-button 10 is used to display an image immediately succeeding the currently displayed image.

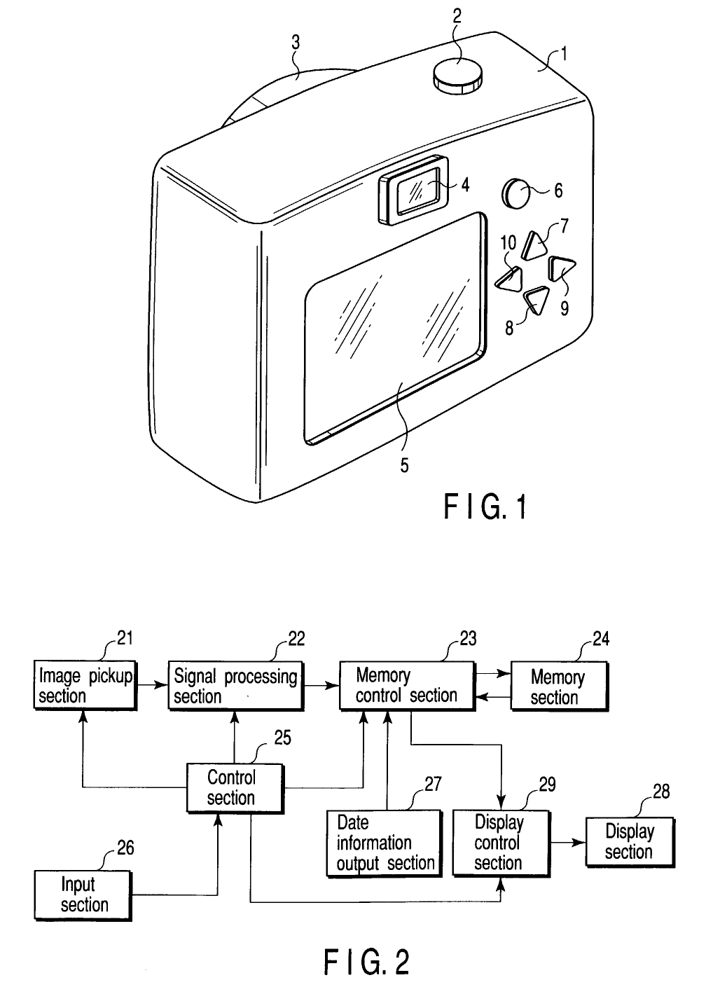

FIG. 2 shows a circuit block of the electronic imaging camera according to an embodiment of the present invention. As shown in FIG. 2, an image pickup section 21 includes the image pickup element and an image pickup optical system to guide an object to the image pickup element. The image pickup section 21 sends a signal to a signal processing section 22. The signal processing section 22 converts the analog image signal sent from the image pickup section 21 into digital image data, adjusts the image quality, compresses data, and the like. The obtained image data is sent to a memory control section 23. The memory control section 23 associates the image data with date information output from a date information output section 27, and stores them in a memory section 24. The memory section 24 can store data equivalent to a plurality of picked-up images. A control section 25 controls an entire sequence and operations of each section. An input section 26 connects with switches interlocking with the release button 2, the image display button 6, the up-button 7, the down-button 8, the right-button 9, and the left-button 10. The input section 26 notifies the control section 25 that any of these buttons are operated. The date information output section 27 outputs date information. A display section 28 works as a liquid crystal display monitor to display a selected image. A display control section 29 controls the display section 28.

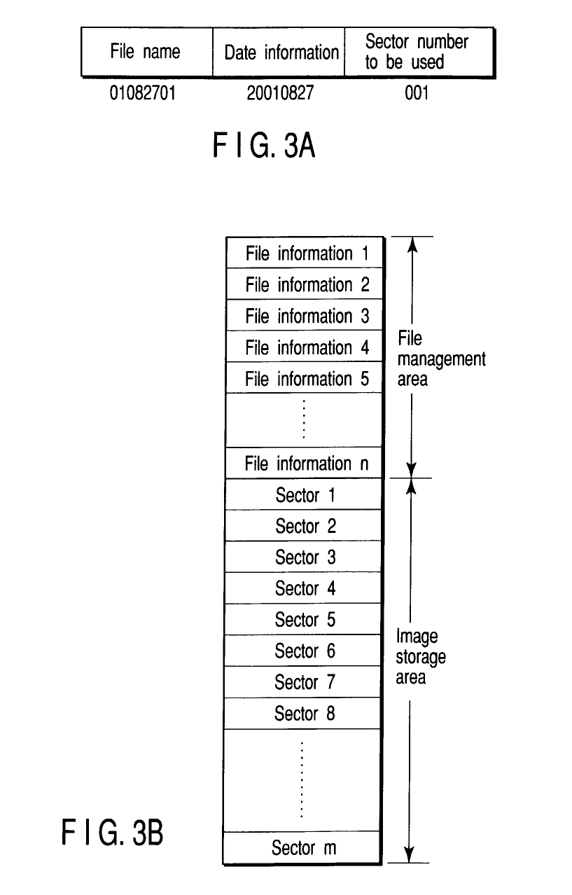

FIGS. 3A and 3B schematically show a data recording area in the memory 24. As shown in FIG. 3B, the data recording area of the memory 24 comprises a file management area and an image storage area. The image storage area stores picked-up image data in the order of sectors 1, 2, and so on. The file management area stores file information corresponding to each sector. For example, sector 1 stores file information 1 correspondingly. As shown in FIG. 3A, the file information manages a file name and date information in addition to the sector information. In this case, the sector is managed as 001, the date as Aug. 27 in 2001, the file name as 01082701.

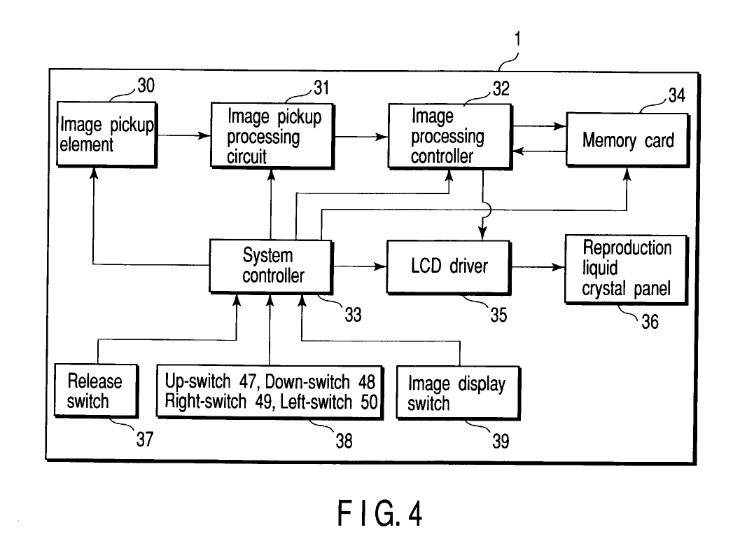

FIG. 4 is a detailed circuit block diagram exemplifying a system configuration of the electronic imaging camera according to the embodiment of the present invention.

The electronic imaging camera according to the embodiment comprises an image pickup element 30 such as a CCD where a light flux from an object enters via the image pickup optical system (not shown); an image pickup processing circuit 31 which reads an image signal obtained by the image pickup element 30 and A/D-converts the signal; an image processing controller 32 which processes the A/D-converted digital image data; a memory card 34 which stores image data; a reproduction liquid crystal panel 36 to display image data; and an LCD driver 35 which controls display operations of the reproduction liquid crystal panel 36.

The image pickup element 30, the image pickup processing circuit 31, and one part of the image processing controller 32 correspond to the image pickup section 21 in FIG. 2. The other part of the image processing controller 32 corresponds to the memory control section 23 in FIG. 2. The memory card 34 corresponds to the memory section 24 in FIG. 2. The LCD driver 35 corresponds to the display control section 29 in FIG. 2. The reproduction liquid crystal panel 36 corresponds to the display section 28 in FIG. 2.

In order to fulfill operations corresponding to user's actions, the electronic imaging camera according to the embodiment is provided with a system controller 33 such as a CPU which controls the image pickup element 30, the image pickup processing circuit 31, the image processing controller 32, the memory card 34, and the LCD driver 35. The system controller 33 corresponds to the control section 25 in FIG. 2.

The system controller 33 connects with a release switch 37 interlocking with the release button 2 in FIG. 1; an up-switch 47, a down-switch 48, a right-switch 49, and a left-switch 50 interlocking with the up-button 7, the down-button 8, the right-button 9, and the left-button 10 in FIG. 1; and an image display switch 39 interlocking with the image display button 6 in FIG. 1. The system controller 33 controls photographing operations, display operations for reproduction, and the like in response to input from these switches. The switches correspond to the input section 26 in FIG. 2. There is also provided a clock function to generate data information. This function corresponds to the date information output section 27 in FIG. 2.

When recording captured image data in the memory card 34, the system controller 33 uses built-in functions to set image file management information as shown in FIG. 3B, record image data correspondingly in a specified area of the memory card 34, and retrieve an image file to be displayed on the reproduction liquid crystal panel 36 by using date information as a retrieval key.

The image processing controller 32 has an image buffer comprising RAM (not shown) or the like. The image processing controller 32 is a circuit which uses the image buffer to apply such image processing to image data as white balancing, coloring, gamma correction, and sharpness adjustment, and JPEG compression and decompression. The image processing controller 32 also has capabilities of reading image data from the memory card 34 in accordance with a control signal from the system controller 33 and displaying the image data on the reproduction liquid crystal panel 36 via the LCD driver 35.

The reproduction liquid crystal panel 36 displays not only reproduced images, but also menu screens. The menus can be used for manipulation of picked-up images such as reproducing, modifying, and deleting images, and various settings such as time setup. The detailed description is omitted here.

Instead of the memory card 34, it may be preferable to use magnetic disks such as a hard disk and a floppy disk (registered trademark), or magnetic optical disks such as an MO.

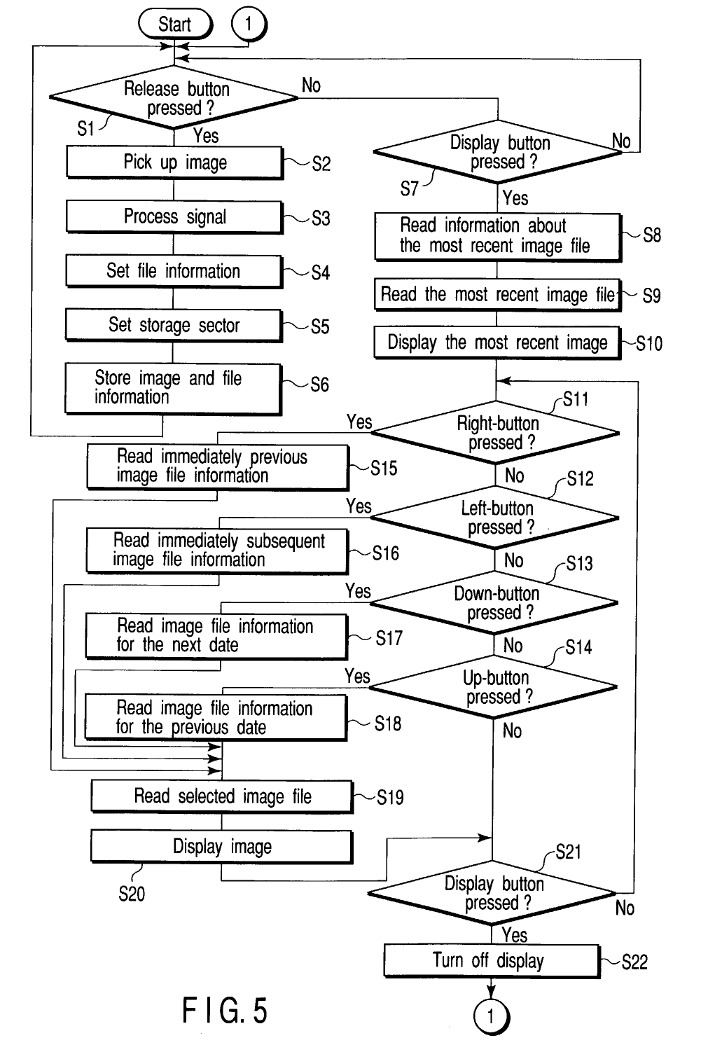

FIG. 5 is a flowchart showing a process of controlling the electronic imaging camera according to the embodiment of the present invention. As shown in FIG. 5, it is determined at step S1 whether or not the release button 2 is pressed based on the state of the release switch 37. When the release button 2 is pressed, the process advances to step S2 to pick up data. At step S3, a signal process is performed for the picked-up data. At step S4, the file information as shown in FIG. 3A is specified for the picked-up data. At step S5, a storage sector is allocated for writing the picked-up data in the memory. At step S6, the picked-up data is recorded in the storage sector. The file management information is recorded in the file management area, and then the process returns to step S1.

If it is determined that the release button 2 is not pressed at step S1, the process advances to step S7 to determine whether or not the image display button 6 is pressed based on the state of the image display switch 39. If the image display button 6 is not pressed, the process returns to step S1. If the image display button 6 is pressed, the process advances to step S8 to read the most recent image file information. At step S9, the most recent image file is read based on the most recent image file information. At step S10, the most recent image is displayed.

While the most recent picked-up image is displayed, it is determined whether or not the right-button 9 is pressed based on the state of the right-switch 49 at step S11. If the right-button 9 is pressed, the process advances to step S15 to read information about an image file that immediately precedes the currently displayed image file, and the process advances to step S19. At step S19, the process reads the image file selected based on the image file information read at step S15. The image is displayed at step S20. The process then advances to step S21 to determine whether or not the image display button 6 is pressed. If the image display button 6 is pressed, the process advances to step S22 to turn off the display and then returns to step S1.

If the right-button 9 is not pressed at step S11, the process advances to step S12 and determines whether or not the left-button 10 is pressed based on the state of the left-switch 50. If the left-button 10 is pressed, the process advances to step S16 to read information about an image file immediately preceding the currently displayed image file, and the process advances to step S19. At step S19, the process reads the image file selected based on the image file information read at step S16. The image is displayed at step S20. The process then advances to step S21 to determine whether or not the image display button 6 is pressed. If the image display button 6 is pressed, the process advances to step S22 to turn off the display and then returns to step S1.

If the left-button 10 is not pressed at step S12, the process advances to step S13 and determines whether or not the down-button 8 is pressed based on the state of the down-switch 48. If the down-button 8 is pressed, the process advances to step S17 to read information about an image file for the next date, and the process advances to step S19. At step S19, the process reads the image file selected based on the image file information read at step S17. The image is displayed at step S20. The process then advances to step S21 to determine whether or not the image display button 6 is pressed. If the image display button 6 is pressed, the process advances to step S22 to turn off the display and then returns to step S1.

If the down-button 8 is not pressed at step S13, the process advances to step S14 and determines whether or not the up-button 7 is pressed based on the state of the up-switch 47. If the up-button 7 is pressed, the process advances to step S18 to read information about an image file for the previous date, and the process advances to step S19. At step S19, the process reads the image file selected based on the image file information read at step S18. The image is displayed at step S20. The process then advances to step S21 to determine whether or not the image display button 6 is pressed. If the image display button 6 is pressed, the process advances to step S22 to turn off the display and then returns to step S1.

When the earliest image is displayed and the right-button 9 is pressed at step S11, no preceding image is available. The process loops to display the most recent image. When the most recent image is displayed and the left-button 10 is pressed at step S12, no succeeding image is available. The process loops to display the earliest image. When the image for the most recent date is displayed and the down-button 8 is pressed at step S13, there is no image for the next date. The process loops to display the first image for the earliest date. When the image for the earliest date is displayed and the up-button 7 is pressed at step S14, there is no image for the previous date. The process displays the first image for the most recent date.

By using the embodiment according to the present invention, it is possible to retrieve and display image data recorded in the memory.

The present invention can efficiently retrieve and display image data recorded in the memory by using date data. This makes it possible to provide the electronic imaging camera having the easy-to-use image reproduction capability.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic imaging camera comprising:
an image pickup element configured to convert an object image into an electric signal via an image pickup optical system;
a signal processing section configured to process output from the image pickup element and generate image data;
a memory section configured to store a plurality of image data;
a date information output section configured to output date information; and
a memory control section configured to control storage operations which associate the image data with the date information from the date information output section, and store them in the memory section and read operations which read the image data stored in the memory section,
wherein the memory control section performs a first read operation to read the image data from the memory section in the sequential order of image pickup and a second read operation to skip the image data of a same date and read the image data of a different date.

2. The electronic imaging camera according to claim 1 further comprising an input section configured to supply the memory control section with a signal for activating the first read operation or the second read operation in response to a manual operation.

3. The electronic imaging camera according to claim 2, wherein the input section outputs first and second signals, and the memory control section performs the first read operation in accordance with the first signal and performs the second read operation in accordance with the second signal.

4. The electronic imaging camera according to claim 1, wherein the second read operation reads as a next read operation image data associated with date information differing from that for the most recently read image data.

5. The electronic imaging camera according to claim 1, wherein the memory control section performs the first read operation to read image data in the forward or reverse order of image pickup based on the most recently read image data and performs a second read operation to read image data having a date previous or subsequent to a date of the most recently read image data.

6. An electronic imaging camera comprising:
an image pickup section configured to pick up an object image;
a date information output section configured to output date information;
a storage section configured to store image data picked up by the image pickup section, the image data being associated with date information output from the date information output section; and
a display section configured to selectively read and display the image data based on the date information as a retrieval key.

7. The electronic imaging camera according to claim 6, further comprising an input section configured to instruct to change image data displayed in the display section, wherein the display section reads and displays image data having a date differing from that for the currently displayed image data in accordance with an instruction signal from the input section.

8. An electronic imaging camera comprising:
a system controller configured to control an overall operation of the electronic imaging camera and includes an date information output circuit to output date information;
an image pickup element configured to convert an object image into an electric signal via an image pickup optical system;
an image pickup processing circuit configured to process output from the image pickup element and generates image data;
a memory card configured to store a plurality of image data;
an image processing controller configured to control storage operations for associating the image data with the date information and storing them in the memory, and read operations for reading the image data stored in the memory section, in accordance with an instruction signal from the system controller;
a display control section configured to convert the read image data into display data; and
a display section configured to display the display data,
wherein the image processing controller performs a first read operation to read the image data from the memory section in the forward or reverse order of image data storage and a second read operation to read the image data by skipping the image data of a same date and read the image data of a different date.

9. The electronic imaging camera according to claim 8, wherein the control circuit is provided with a plurality of switches and outputs a read control signal to the image processing controller in accordance with a signal from the switch.

10. The electronic imaging camera according to claim 9, wherein the control circuit supplies the image processing controller with the control signal to perform the first read operation in accordance with first and second switch signals out of the plurality of switches and supplies the control signal to perform the second read operation in accordance with third and fourth switch signals out of the plurality of switches.
